(19) United States
(12) Patent Application Publication
(10) Pub. No.: US 2012/0092805 A1
(43) Pub. Date: Apr. 19, 2012

(54) COMPUTER ENCLOSURE

(75) Inventor: QIANG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/912,775

(22) Filed: Oct. 27, 2010

(30) Foreign Application Priority Data
Oct. 13, 2010 (CN) 201010505783.0

(51) Int. Cl. H01T 23/00

(52) U.S. Cl. 361/231

(57) ABSTRACT

A computer enclosure includes a case, a system fan, and a negative ion generator. The case defines an air outlet. The system fan is arranged in the case adjacent to the air outlet. The negative ion generator is arranged in the case to generate negative ions. The generated negative ions spread in the case and are expelled from the case through the air outlet by airflow generated by the system fan.

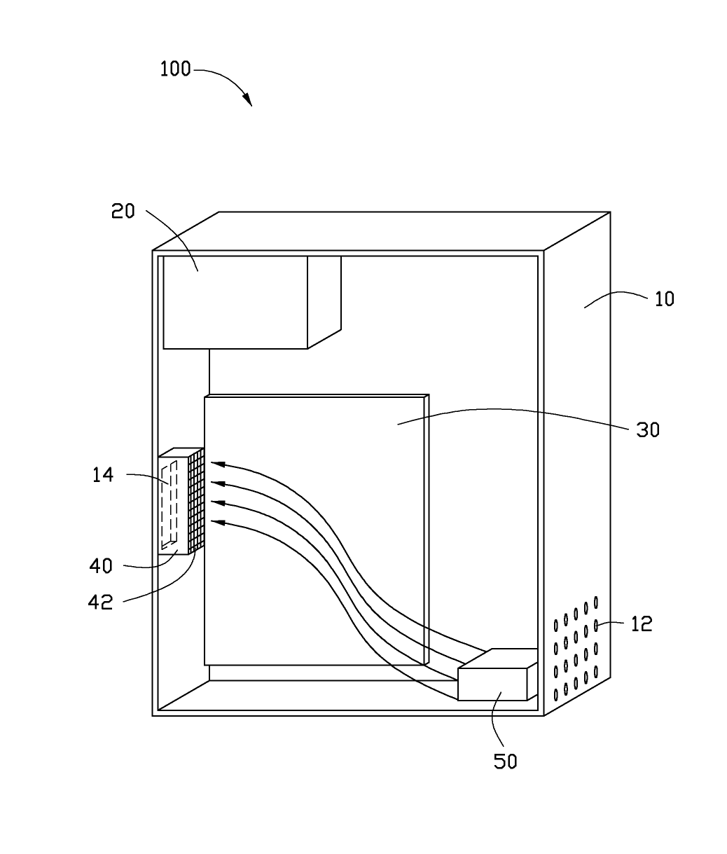

### BACKGROUND

1. Technical Field

The present disclosure relates to a computer enclosure.

2. Description of Related Art

Computers are widely used, and people always use the computers to work in offices or rooms. Most time, the air quality in the offices or rooms is not good for health. Therefore there is room for improvement in the art.

### BRIEF DESCRIPTION OF THE DRAWING

Many aspects of the present embodiments can be better understood with reference to the following drawing. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

The drawing is a partial, inside schematic view of an embodiment of a computer enclosure.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the drawing, an embodiment of a computer enclosure 100 includes a case 10, with a power supply 20, a motherboard 30, a system fan 40, and a negative ion generator 50 all arranged in the case 10. It may be understood that the computer enclosure 100 also includes other elements, such as hard disk drivers, memory chips. These other elements fall within well-known technologies, and are therefore not described here.

The power supply 20 supplies power to the motherboard 30, the system fan 40, and the negative ion generator 50. The power supply 20, the motherboard 30, and the system fan 40 fall within well-known technologies, and therefore their circuitries are not described here.

The negative ion generator 50 is used to generate negative ions. The negative ion generator 50 is arranged in the case 10 adjacent to an air intake 12 of the case 10. When the negative ion generator 50 is turned on by turning on the power supply 20, the negative ion generator 50 emits a lot of electrons, and the electrons combine with oxygen molecules to generate negative ions. The negative ions generated by the negative ion generator 50 will spread in the case 10.

On the one hand, the negative ions generated by the negative ion generator 50 neutralize static electricity of the motherboard 30, the power supply 20, and other elements in the case 10, and can form negative ion protecting layers on the motherboard 30, the power supply 20, or the other elements, thereby preventing damage caused by static electricity. Furthermore, the negative ions generated by the negative ion generator 50 also neutralize electrical charge of dust floating in the case 10, so the dust can be easily expelled by airflow rather than being attracted by surfaces of components in the case 10.

On the other hand, the negative ions generated by the negative ion generator 50 are expelled through the air outlet 14 of the case 10, along an airflow path (small solid arrows stands for the airflow path in the drawing) of airflow generated by the system fan 40. When the negative ions are removed to outside of the case 10, the ambient air benefits from the negative ions, and thus a healthier environment is provided for users.

In one embodiment, the system fan 40 includes a dust filter 42 removably mounted on the system fan 40. The dust filter 42 can filter dust from the air flowing through the filter 42. The dust filter 42 can be removed and cleaned as needed.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer enclosure comprising:
a case defining an air outlet;
a system fan arranged in the case adjacent to the air outlet; and
a negative ion generator arranged in the case and operable to generate negative ions, wherein the generated negative ions spread in the case and are expelled from the case through the air outlet by airflow generated by the system fan.

2. The computer enclosure of claim 1, wherein the case further defines an air intake, the negative ion generator is adjacent to the air intake.

3. The computer enclosure of claim 1, wherein the system fan comprises a dust filter removably mounted on the system fan.
